(19) United States
(12) Patent Application Publication
(10) Pub. No.: US 2011/0141290 A1
(43) Pub. Date: Jun. 16, 2011

(54) SYSTEM AND METHOD FOR TESTING VIDEO GRAPHICS ARRAY SIGNAL GROUPS

(75) Inventors: JUI-HSIUNG HO, Tu-Cheng (TW); YUNG-CHENG HUNG, Tu-Cheng (TW); WANG-DING SU, Tu-Cheng (TW)

(73) Assignee: HON HAI PRECISION INDUSTRY CO., LTD., Tu-Cheng (TW)

(21) Appl. No.: 12/781,820

(22) Filed: May 18, 2010

(30) Foreign Application Priority Data
Dec. 16, 2009 (TW) 98143034

(51) Int. Cl. H04N 17/00

(52) U.S. Cl. 348/184; 348/E17.001

(57) ABSTRACT

A system and method for testing video graphics array (VGA) signal groups includes configuring a route parameter of each of the VGA signal groups, establishing a connection between an input channel and an output channel of a signal channel selector corresponding to each of the VGA signal groups, and transferring each of the VGA signal groups to the digital oscilloscope through the connection. The system and method further includes enabling the digital oscilloscope to analyze each of the VGA signal groups and acquire analysis results of each of the VGA signal groups.

### BACKGROUND

1. Technical Field

Embodiments of the present disclosure relate to image signal testing, and more particularly to a system and a method for testing video graphics array (VGA) signal groups.

2. Description of Related Art

Generally, multiple VGA signal groups are tested using a digital oscilloscope, such as H Sync, V Sync, R, G, and B signals, for example. Some digital oscilloscopes only have four probes to receive the multiple VGA signal groups. However, if five VGA signal groups need to be tested using the digital oscilloscope having four probes, testers have to switch the probes to receive the five VGA signal groups manually. It is inconvenient and inefficient to test the VGA signals manually.

What is needed, therefore, is an improved system and a method for testing VGA signal groups.

### BRIEF DESCRIPTION OF THE DRAWINGS

FIG. 1 is a block diagram of one embodiment of a computer including a test system.

FIG. 2 is a schematic diagram of one embodiment of a signal channel selector in communication with a digital oscilloscope.

FIG. 3 is a schematic diagram of one embodiment of a list of route parameters of multiple video graphics array (VGA) signal groups.

FIG. 4 is a flowchart of an embodiment of a method for testing VGA signal groups using the test system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprised connected logic units, such as gates and flip-flops, and may comprise program-controlled units, such as program-controlled gate arrays or processors. The modules described herein may be implemented as either software and/or hardware modules and may be stored in any type of computer-readable medium or other computer storage device.

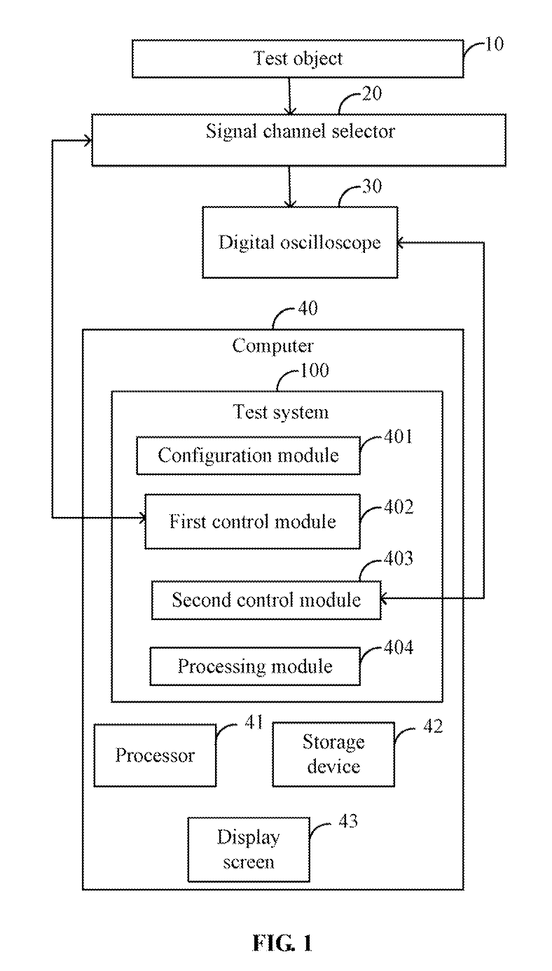

FIG. 1 is a block diagram of one embodiment of a computer 40 including a test system 100 that tests video graphics array (VGA) signal groups. In one embodiment, the test system 100 may be used to test VGA signals output by a test object 10, such as a mobile phone, a personal digital assistant, or a notebook computer, for example. The computer 40 is connected to a signal channel selector 20 and a digital oscilloscope 30. The test object 10 is connected to the digital oscilloscope 30 via the signal channel selector 20.

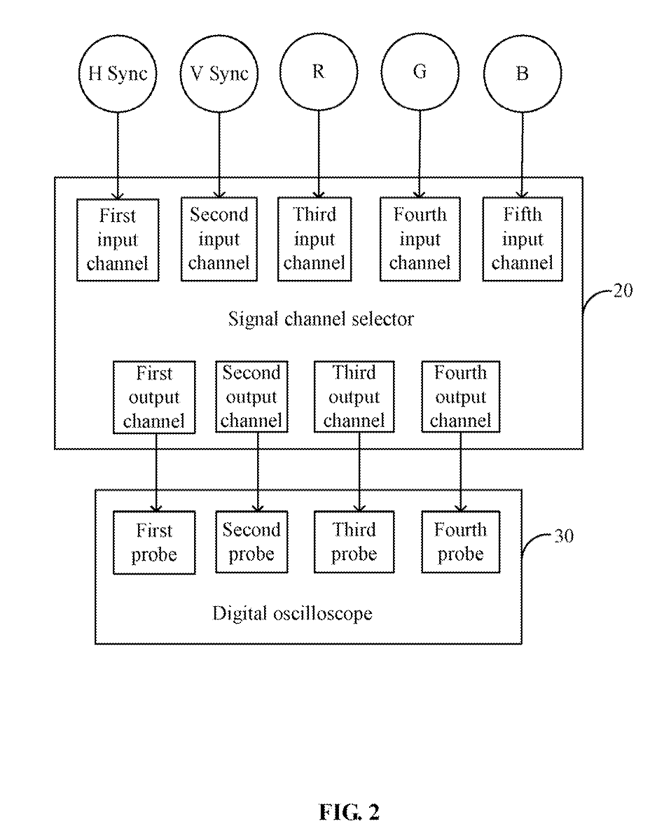

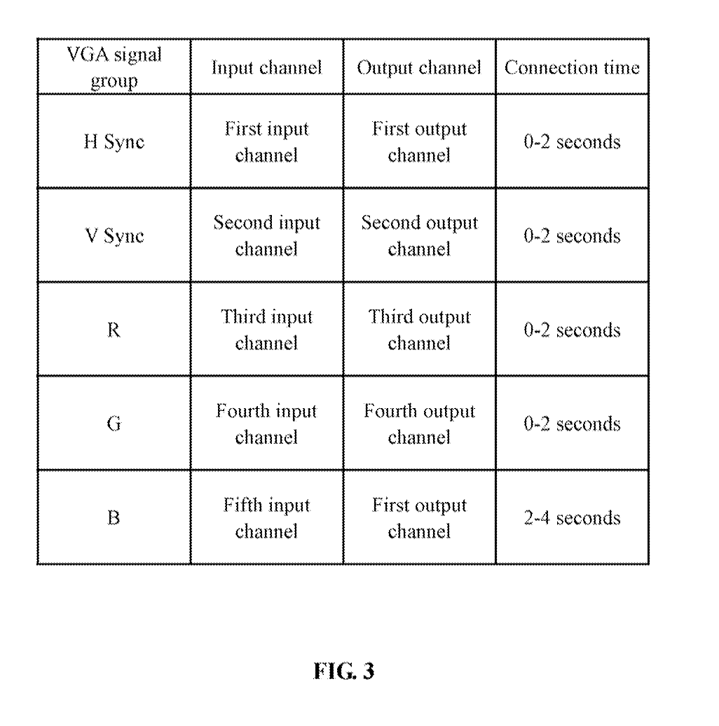

As shown in FIG. 2, the signal channel selector 20 includes five program-controlled input channels and four program-controlled output channels. In one embodiment, the five program-controlled input channels of the signal channel selector 20 may include a first input channel, a second input channel, a third input channel, a fourth input channel, and a fifth input channel. The four program-controlled output channels of the signal channel selector 20 may include a first output channel, a second output channel, a third output channel, and a fourth output channel.

In one embodiment, the test object 10 may output a plurality of VGA signal groups to the signal channel selector 20. In one embodiment, the test object 10 outputs five VGA signal groups to the signal channel selector 20 through the five program-controlled input channels respectively. As shown in FIG. 2, the five VGA signal groups may include H Sync, V Sync, R, G, and B signal groups. The “H Sync” VGA signal group is output to the signal channel selector 20 through the first input channel. In another embodiment, the test object 10 may output any other VGA signal groups different from the five VGA signal groups as mentioned above.

The five VGA signal groups may be transferred from the signal channel selector 20 to the digital oscilloscope 30 through the four program-controlled output channels. The four program-controlled output channels of the signal channel selector 20 are connected to four probes of the digital oscilloscope 30, such as, a first probe, a second probe, a third probe, and a fourth probe. The digital oscilloscope 30 may analyze the five VGA signal groups output from the test object 10, and acquire corresponding analysis results of each of the VGA signal groups. Detailed descriptions about the analysis process will be provided below.

The computer 40 further includes a processor 41, a storage device 42, and a display screen 43. The processor 41 executes one or more computerized operations of the computer 40 and other applications, to provide functions of the computer 40. The storage device 42 stores one or more programs of the computer 40, and various kinds of data, such as the analysis results, for example. In one embodiment, the storage device 42 may be a memory of the computer 40, or an external storage card, such as a memory stick, a smart media card, a compact flash card, or any other type of memory media. The display screen 43 may display various visible data, such as the analysis results of each of the VGA signal groups.

In one embodiment, the test system 100 includes a configuration module 401, a first control module 402, a second control module 403, and a processing module 404. The modules 401, 402, 403, and 404 may include one or more computerized codes to be executed by the processor 41 to perform one or more operations of the test system 100. Details of the operations are provided below.

After the test object 10, the signal channel selector 20, the digital oscilloscope 30, and the computer 40 are connected as shown in FIG. 1 and FIG. 2, the configuration module 401 configures a route parameter for each of the VGA signal groups. In one embodiment, the route parameter includes an input channel and an output channel of the signal channel selector 20 corresponding to each of the VGA signal groups. In addition, the route parameter further includes a connection time corresponding to each of the VGA signal groups. As shown in FIG. 3, a specific input channel, a specified output channel, and a specified connection time are assigned to each of the five VGA signal groups.

The configuration module 401 further sets a plurality of test parameters to test the VGA signal groups. In one embodiment, the test parameters may include, but are not limited to, types of the multiple VGA signal groups, test items of each of the VGA signal groups, test items of an image, test times, and a resolution of the computer 40 corresponding to each of the VGA signal groups.

For example, as shown in FIG. 5, a “RED” (R) signal group may correspond to test items from “High” to “Ringback.” The test items from “High” to “to Green Skew” may correspond to a black-and-white image as shown in FIG. 6. The test item “to Green Mismatch” may correspond to a black-to-white image, for example, as it is shown in FIG. 7. The test items from “Back Porch” to “Ringback” may correspond to a white image, for example, as it is shown in FIG. 8.

The first control module 402 establishes a connection between the input channel and the output channel of the signal channel selector 20 corresponding to each of the VGA signal groups during the connection time. The first control module 402 further transfers each of the VGA signal groups to the digital oscilloscope 30 through the connection. For example, during a connection time of “0-2 seconds”, the first control module 402 establishes a connection between the first input channel and the first output channel of the signal channel selector 20 to transfer the “H Sync” VGA signal group. For another example, during a connection time of “2-4 seconds”, the first control module 402 establishes a connection between the fifth input channel and the first output channel of the signal channel selector 20 to transfer the “B” VGA signal group.

The second control module 403 sends control signals to the digital oscilloscope 30, and enables the digital oscilloscope 30 to analyze each of the VGA signal groups according to the control signals and acquire analysis results of each of the VGA signal groups. The second control module 403 further reads the analysis results of each of the VGA signal groups from the digital oscilloscope 30. A detailed example is provided below.

In one embodiment, the second control module 403 determines a test item of each of the VGA signal groups, and selects an image according to the test item. For example, the image is a composite image that is integrated by a black-and-white image, a black-to-white image, and a white image, as shown in FIG. 9. In another embodiment, the image is selected from the group consisting of a black-and-white image, a black-to-white image, and a white image.

The digital oscilloscope 30 regulates a wave shape of each of the VGA signal groups, to occupy a whole display interface of the display screen 43. Furthermore, the digital oscilloscope 3 regulates a resolution of the whole display interface according to the test parameters.

The digital oscilloscope 30 analyzes each of the VGA signal groups according to the test item and the regulated wave shape, to generate an analysis result corresponding to the test item of each of the VGA signal groups. Furthermore, the digital oscilloscope 30 may determine whether all the test items corresponding to each of the VGA signal groups have been analyzed. In addition, the digital oscilloscope 30 analyzes whether the analysis of each of the VGA signal groups has been completed according to the test times, and analyzes whether all of the multiple VGA signal groups have been analyzed.

The processing module 404 generates a test report including the analysis results of each of the VGA signal groups read from the second control module 403. The test report may be displayed on the display screen 43, or be printed using a printer connected to the computer 40.

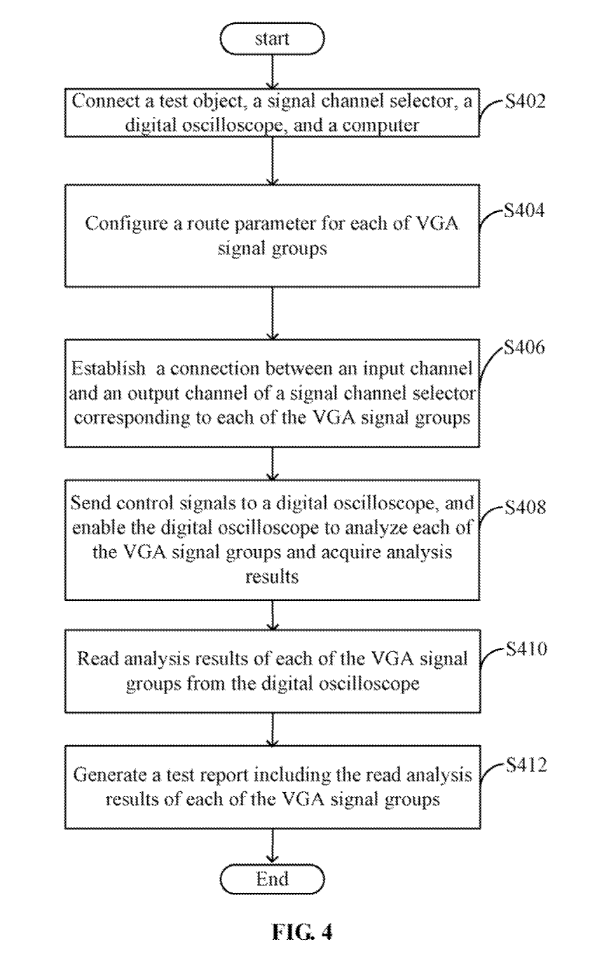

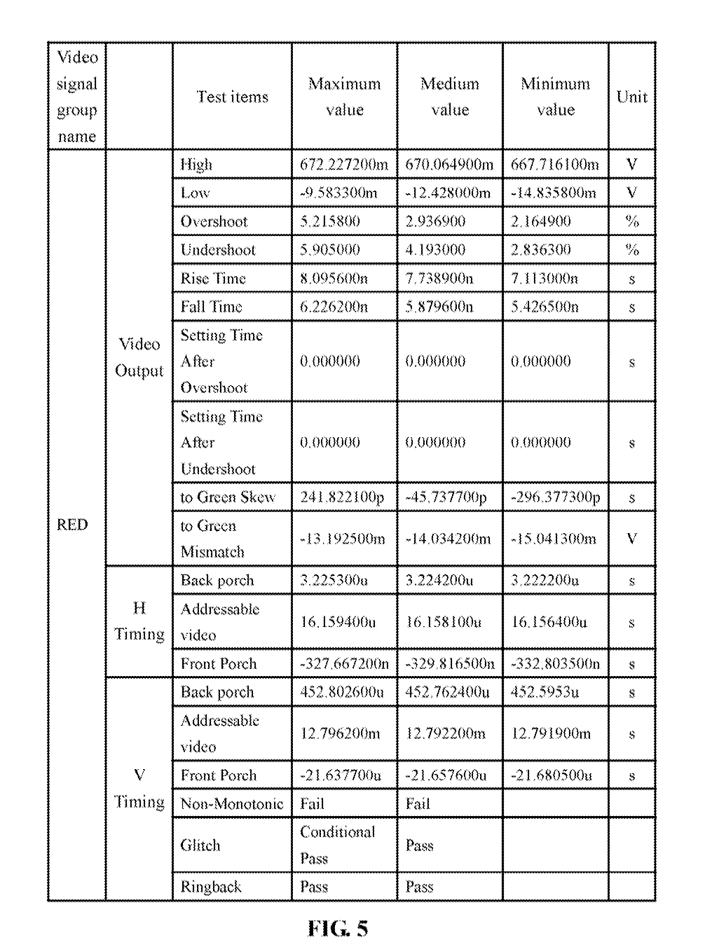

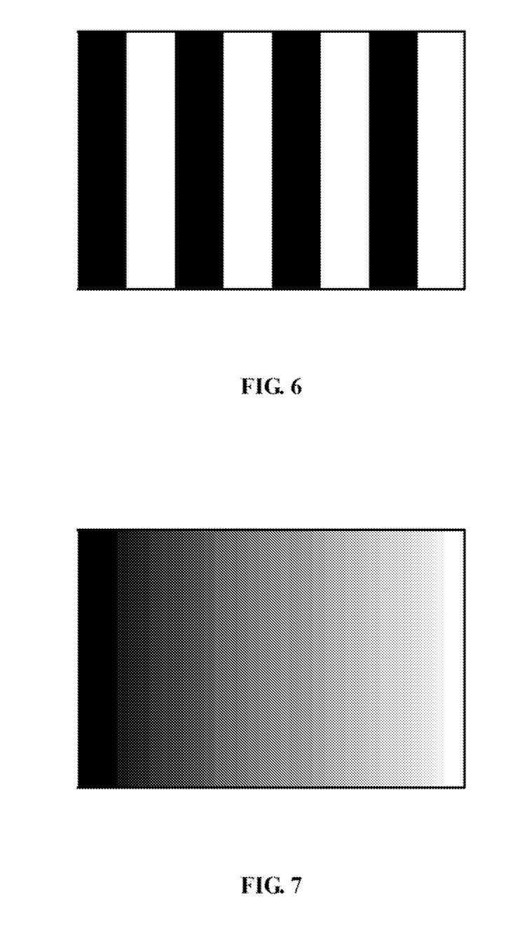

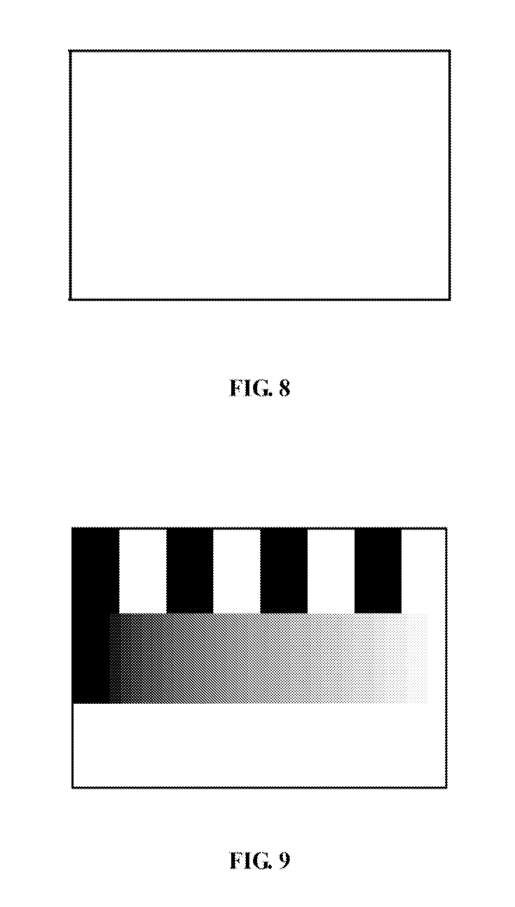

FIG. 4 is a flowchart of an embodiment of a method for testing VGA signal groups using the test system 100 of FIG. 1. Depending on the embodiment, additional blocks may be added, others removed, and the ordering of the blocks may be replaced.

In block S402, the test object 10, the signal channel selector 20, the digital oscilloscope 30, and the computer 40 are connected as shown in FIG. 1 and FIG. 2.

In block S404, the configuration module 401 configures a route parameter for a VGA signal group output by the test object 10. As mentioned above, the route parameter includes an input channel and an output channel of the signal channel selector 20 corresponding to the VGA signal group, and a connection time corresponding to the VGA signal group.

In block S406, during the connection time, the first control module 402 establishes a connection between the input channel and the output channel of the signal channel selector 20 corresponding to the VGA signal group, and transfers the VGA signal group to the digital oscilloscope 30 through the connection.

In block S408, the second control module 403 sends control signals to the digital oscilloscope 30, and enables the digital oscilloscope 30 to analyze the VGA signal group according to the control signals and acquire analysis results of the VGA signal group. Detailed descriptions of the analysis process have been described above.

In block S410, the second control module 403 reads the analysis results of the VGA signal group from the digital oscilloscope 30.

In block S412, the processing module 404 generates a test report including the analysis results of each of the VGA signal group.

By repeating block S404 to S412, multiple VGA signal groups output by the test object may be automatically tested using the test system 100.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer system for testing video graphics array (VGA) signal groups output by a test object, the computer system in communication with a signal channel selector and a digital oscilloscope, the computer system comprising:
a storage device;
at least one processor; and
one or more programs stored in the storage device and being executable by the at least one processor, the one or more programs comprising:
a configuration module operable to configure a route parameter for each of the VGA signal groups, the route parameter comprising an input channel and an output channel of the signal channel selector corresponding to each of the VGA signal groups, and a connection time to connect the input channel to the output channel;
a first control module operable to establish a connection between the input channel and the output channel of the signal channel selector corresponding to each of the VGA signal groups during the connection time, and transfer each of the VGA signal groups to the digital oscilloscope through the connection; and
a second control module operable to send control signals corresponding to each of the VGA signal groups to the digital oscilloscope, enable the digital oscilloscope to analyze each of the VGA signal groups according to the control signals and acquire analysis results of each of the VGA signal groups.

2. The computer system according to claim 1, wherein the second control module is further operable to read the analysis results of each of the VGA signal groups from the digital oscilloscope.

3. The computer system according to claim 2, wherein the one or more programs further comprises a processing module operable to generate a test report comprising the analysis results of each of the VGA signal groups.

4. The computer system according to claim 1, wherein the signal channel selector comprises five program-controlled input channels and four program-controlled output channels.

5. The computer system according to claim 4, wherein five VGA signal groups are input to the signal channel selector through the five program-controlled input channels.

6. The computer system according to claim 4, wherein the four program-controlled output channels of the signal channel selector are connected to four probes of the digital oscilloscope.

7. A method for testing video graphics array (VGA) signal groups output by a test object, the test object in communication with a signal channel selector, the signal channel selector in communication with a digital oscilloscope, the method comprising:
configuring a route parameter for each of the VGA signal groups, the route parameter comprising an input channel and an output channel of the signal channel selector corresponding to each of the VGA signal groups, and a connection time to connect the input channel to the output channel;
establishing a connection between the input channel and the output channel of the signal channel selector corresponding to each of the VGA signal groups during the connection time, and transferring each of the VGA signal groups to the digital oscilloscope through the connection; and
sending control signals corresponding to each of the VGA signal groups to the digital oscilloscope, enabling the digital oscilloscope to analyze each of the VGA signal groups according to the control signals and acquire analysis results of each of the VGA signal groups.

8. The method according to claim 7, further comprising:
reading the analysis results of each of the VGA signal group from the digital oscilloscope.

9. The method according to claim 8, further comprising:
generating a test report comprising the analysis results of each of the VGA signal groups.

10. The method according to claim 7, wherein the signal channel selector comprises five program-controlled input channels and four program-controlled output channels.

11. The method according to claim 10, wherein five VGA signal groups are input to the signal channel selector through the five program-controlled input channels.

12. The method according to claim 10, wherein the four program-controlled output channels of the signal channel selector are connected to four probes of the digital oscilloscope.

13. A storage medium storing a set of instructions, the set of instructions capable of being executed by a processor to perform a method for testing video graphics array (VGA) signal groups output by a test object, the test object in communication with a signal channel selector, the signal channel selector in communication with a digital oscilloscope, the method comprising:
configuring a route parameter for each of the VGA signal groups, the route parameter comprising an input channel and an output channel of the signal channel selector corresponding to each of the VGA signal groups, and a connection time to connect the input channel to the output channel;
establishing a connection between the input channel and the output channel of the signal channel selector corresponding to each of the VGA signal groups during the connection time, and transferring each of the VGA signal groups to the digital oscilloscope through the connection; and
sending control signals corresponding to each of the VGA signal groups to the digital oscilloscope, enabling the digital oscilloscope to analyze each of the VGA signal groups according to the control signals and acquire analysis results of each of the VGA signal groups.

14. The storage medium as claimed in claim 13, wherein the method further comprises:
reading the analysis results of each of the VGA signal group from the digital oscilloscope.

15. The storage medium as claimed in claim 14, wherein the method further comprises:
generating a test report comprising the analysis results of each of the VGA signal groups.

16. The storage medium as claimed in claim 13, wherein the signal channel selector comprises five program-controlled input channels and four program-controlled output channels.

17. The storage medium as claimed in claim 16, wherein five VGA signal groups are input to the signal channel selector through the five program-controlled input channels.

18. The storage medium as claimed in claim 16, wherein the four program-controlled output channels of the signal channel selector are connected to four probes of the digital oscilloscope.
